(19) United States
(12) Patent Application Publication
(10) Pub. No.: US 2024/0387809 A1
(43) Pub. Date: Nov. 21, 2024

(54) METHOD FOR MANUFACTURING SILICON CLATHRATE ELECTRODE ACTIVE MATERIAL, AND METHOD FOR MANUFACTURING LITHIUM-ION BATTERY

(71) Applicant: TOYOTA JIDOSHA KABUSHIKI KAISHA, Toyota-shi (JP)

(72) Inventors: Naohiro MASHIMO, Atsugi-shi (JP); Mitsutoshi Otaki, Susono-shi (JP); Jun Yoshida, Mishima-shi (JP)

(73) Assignee: TOYOTA JIDOSHA KABUSHIKI KAISHA, Toyota-shi (JP)

(21) Appl. No.: 18/632,926

(22) Filed: Apr. 11, 2024

(30) Foreign Application Priority Data
May 16, 2023 (JP) 2023-080996

(51) Int. Cl. H01M 4/38; H01M 4/02; H01M 10/0525

(52) U.S. Cl. CPC H01M 4/386; H01M 10/0525; H01M 2004/021; H01M 2004/027

(57) ABSTRACT

The present disclosure provides a method for manufacturing a silicon clathrate electrode active material capable of improving the treatment efficiency of a sodium-containing silicon clathrate in a sodium removal step and capable of reducing the amount of sodium remaining in the obtained silicon clathrate electrode active material, and a method for manufacturing a lithium-ion battery comprising manufacturing such a silicon clathrate electrode active material. The method of the present disclosure for manufacturing a silicon clathrate electrode active material comprises (a) providing a sodium-containing silicon clathrate; and (b) contacting the sodium-containing silicon clathrate with a hydrogen fluoride solution to remove at least a portion of sodium from the sodium-containing silicon clathrate.

### FIELD

The present disclosure relates to a method for manufacturing a silicon clathrate electrode active material and a method for manufacturing a lithium-ion battery.

### BACKGROUND

In recent years, there has been ongoing development of batteries. For example, in the automotive industry, the development of batteries for use in electric vehicles or hybrid vehicles has been advancing. In addition, silicon is known as an electrode active material used in batteries, particularly lithium-ion batteries.

Silicon electrode active materials have a large theoretical capacity and are effective in high energy densification of batteries. However, silicon electrode active materials have a problem of large expansion during charging. On the other hand, it is known that using a silicon clathrate electrode active material as a silicon electrode active material suppresses expansion during charging.

For example, PTL 1 discloses a silicon clathrate electrode active material comprising a silicon clathrate type II crystal phase and including voids inside primary particles, wherein a void amount of the voids having a fine pore diameter of 100 nm or less is 0.05 cc/g or more and 0.15 cc/g or less.

### CITATION LIST

### Patent Literature

[PTL 1] Japanese Unexamined Patent Publication (Kokai) No. 2021-158004

### SUMMARY

### Technical Problem

Although silicon clathrate electrode active materials can be produced by removing sodium from sodium-containing silicon clathrates, there is a demand for an improvement in the treatment efficiency of the sodium-containing silicon clathrate in this step and a reduction in the amount of sodium remaining in the obtained silicon clathrate electrode active material.

An object of the present disclosure is to provide a method for manufacturing a silicon clathrate electrode active material capable of improving the treatment efficiency of a sodium-containing silicon clathrate in a sodium removal step and capable of reducing the amount of sodium remaining in the obtained silicon clathrate electrode active material, and a method for manufacturing a lithium-ion battery comprising manufacturing such a silicon clathrate electrode active material.

### Solution to Problem

The present inventors have discovered that the above object can be achieved by the following means.

### <Aspect 1>

A method for manufacturing a silicon clathrate electrode active material, comprising the following steps:
(a) providing a sodium-containing silicon clathrate; and
(b) contacting the sodium-containing silicon clathrate with a hydrogen fluoride solution to remove at least a portion of sodium from the sodium-containing silicon clathrate.

### <Aspect 2>

The method according to Aspect 1, wherein the solvent of the hydrogen fluoride solution is a mixed solvent of water and an organic solvent.

### <Aspect 3>

The method according to Aspect 1 or 2, wherein the sodium-containing silicon clathrate has a porous structure.

### <Aspect 4>

The method according to any one of Aspects 1 to 3, wherein the silicon clathrate electrode active material is for a negative electrode active material of lithium-ion batteries.

### <Aspect 5>

A method for manufacturing a lithium-ion battery, comprising the following steps:
manufacturing a silicone clathrate electrode active material by the method according to any one of Aspects 1 to 4, and
forming an electrode active material layer containing the silicon clathrate electrode active material.

### Advantageous Effects of Invention

According to the method of the present disclosure for manufacturing a silicon clathrate electrode active material, it is possible to improve the treatment efficiency of the sodium-containing silicon clathrate in the sodium removal step and to reduce the amount of sodium remaining in the obtained silicon clathrate electrode active material. In addition, in the present disclosure, it is possible to provide a method for manufacturing a lithium-ion battery comprising manufacturing a silicon clathrate electrode active material.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

### <<Method for Manufacturing Silicon Clathrate Electrode Active Material>>

The method of the present disclosure for manufacturing a silicon clathrate electrode active material comprises (a) providing a sodium-containing silicon clathrate; and (b) contacting the sodium-containing silicon clathrate with a hydrogen fluoride solution to remove at least a portion of sodium from the sodium-containing silicon clathrate.

As a method for manufacturing silicone clathrate electrode active materials comprises, for example, sodium (Na) is removed from the sodium-containing silicon clathrate by mixing the sodium-containing silicon clathrate (e.g., Na₂₀ Si₁₃₆) with zinc chloride and firing the mixture to obtain silicon clathrate (e.g., Na₂ Si₁₃₆) with reduced sodium content.

However, since the reaction in this method is a solid-state reaction, a relatively long reaction time is required. The present inventors have found that Na can be efficiently removed from the sodium-content silicon clathrate by contacting the sodium-containing silicon clathrate with a hydrogen fluoride (HF) solution in place of or in addition to this reaction.

The “electrode active material” relating to the present disclosure can be used as a “positive electrode active material” or a “negative electrode active material”, and is used particularly as a “negative electrode active material”.

### <Provision of Sodium-Containing Silicone Clathrate>

The method of the present disclosure comprises providing a sodium-containing silicon clathrate.

Sodium-containing silicone clathrates can be prepared by removing sodium from sodium silicone (NaSi) alloys.

Specifically, a NaSi alloy is prepared by first reacting a silicon source with a sodium source such as sodium hydride. Thereafter, a silicon clathrate can be prepared by heating the NaSi alloy thus prepared to remove sodium from the NaSi alloy to form clathrate. Alternatively, a silicon clathrate can be prepared by reacting the NaSi alloy thus prepared with aluminum fluoride as a sodium trapping agent to remove sodium from the NaSi alloy to form clathrate.

The sodium-containing silicon clathrate may have a porous structure. In this case, it is preferable that the contact area between the sodium-containing silicon clathrate and the hydrogen fluoride (HF) solution is large, and the removal efficiency of Na is improved.

### <Removal of Sodium>

The method of the present disclosure comprises contacting a sodium-containing silicon clathrate with a hydrogen fluoride solution to remove at least a portion of sodium from the sodium-containing silicon clathrate.

A solvent of the hydrogen fluoride solution may be water, an organic solvent, or a mixed solvent of water and an organic solvent. When this solvent contains water, i.e., a mixed solvent of water and an organic solvent, particularly a mixed solvent of water and an organic solvent, it is preferable in that the production of by-product such as sodium silicofluoride (Na₂ SiF₆) is suppressed.

It is preferable that the solvent contains an organic solvent in that the amount of water remaining in the silicon clathrate electrode active material can be reduced. The ratio of the organic solvent in this solution may be 80% by mass or greater, 90% by mass or greater, or 95% by mass or greater.

The organic solvent can be any organic solvent that can dissolve hydrogen fluoride. When the organic solvent is used in combination with water, the organic solvent may be any organic solvent that can dissolve hydrogen fluoride and is compatible with water. The organic solvent is preferably an alcohol, more preferably a lower alcohol, and still more preferably ethanol.

In the method of the present disclosure, the ratio of the amount of substance of the hydrogen fluoride (mol) to the mass of the silicone clathrate (g) (HF [mol]/Si [g]) may be 0.01 mol/g or greater, 0.02 mol/g or greater, 0.03 mol/g or greater, or 0.04 mol/g or greater, and may be 0.20 mol/g or less. When this ratio is within the above range, Na can be efficiently removed from the sodium-containing silicon clathrate.

As a method of contacting the sodium-containing silicon clathrate with the hydrogen fluoride solution, a mixing operation such as stirring is exemplified, but is not limited thereto.

The time for contacting the sodium-containing silicon clathrate with the hydrogen fluoride solution may be 0.5 h or more, 1 h or more, or 2 h or more, and may be 6 h or less, 5 h or less, or 4 h or less.

In the silicon clathrate electrode active material manufactured in the method of the present disclosure, the amount of sodium in the silicon clathrate electrode active material may be 6.5% by mass or less, 6.0% by mass or less, 5.5% by mass or less, 5.2% by mass or less, 5.0% by mass or less, 4.8% by mass or less, or 4.6% by mass or less.

The amount of sodium in the silicon clathrate electrode active material can be measured, for example, by inductively coupled plasma (ICP) analysis.

### <Uses>

The silicon clathrate electrode active material obtained by the method of the present disclosure can be used for a negative electrode active material of lithium-ion batteries.

### <<Manufacturing Method for Lithium-Ion Battery>>

The method of the present disclosure for manufacturing a lithium-ion battery comprises manufacturing a silicon clathrate electrode active material by the method of the present disclosure and forming an electrode active material layer containing the silicon clathrate electrode active material.

For a method for manufacturing a silicon clathrate electrode active material, reference can be made to the above description relating to a method for manufacturing a silicon clathrate electrode active material of the present disclosure.

A method of forming the electrode active material layer is not particularly limited, and a known method can be employed. For example, when the negative electrode active material layer contains the silicon clathrate electrode active material of the present disclosure, a slurry containing the silicon clathrate electrode active material is coated on the negative electrode current collector and dried, whereby an electrode active material layer formed on the negative electrode current collector layer, that is, a negative electrode active material layer can be obtained.

A method of forming a battery is not particularly limited, and a known method can be employed. Hereinafter, a method for manufacturing a battery when the negative electrode active material layer contains the silicon clathrate electrode active material of the present disclosure will be described.

A method for manufacturing a battery in the present disclosure may comprise, in addition to manufacturing a silicon clathrate electrode active material and forming a negative electrode active material layer containing a silicon clathrate electrode active material, disposing a negative electrode current collector layer, a negative electrode active material layer, an electrolyte layer, a positive electrode active material layer, and a positive electrode current collector layer in this order.

### <Negative Electrode Current Collector Layer>

The material used for the negative electrode current collector layer is not particularly limited. Any material that can be used as a negative electrode current collector of a battery can be appropriately adopted. For example, the material may be, but is not limited to, copper, copper alloy, or copper plated or vapor-deposited with nickel, chromium, or carbon.

The shape of the negative electrode current collector layer is not particularly limited, and can include, for example, foil-like, plate-like, or mesh-like. Among these, a foil-like shape is preferable.

### <Negative Electrode Active Material Layer>

The negative electrode active material layer of the present disclosure is a layer containing a negative electrode active material and optionally a solid electrolyte, a conductive aid, and a binder.

### (Negative Electrode Active Material)

The negative electrode active material comprises the silicon clathrate electrode active material of the present disclosure.

### (Electrolyte)

The material of the solid electrolyte is not particularly limited. Any material that is usable as a solid electrolyte used in lithium-ion batteries can be used. For example, the solid electrolyte may be a sulfide solid electrolyte.

Examples of the sulfide solid electrolyte include, but are not limited to, sulfide amorphous solid electrolytes, sulfide crystalline solid electrolytes, and argyrodite-type solid electrolytes. Specific examples of the sulfide solid electrolyte can include, but are not limited to, Li₂ S—P₂ S5-based (such as Li₇ P₃ S₁₁, Li₃ PS₄, and Li₈ P₂ S₉), Li₂ S—SiS₂, LiI—Li₂ S—SiS₂, LiI—Li₂ S—P₂ S₅, LiI—LiBr—Li₂ S—P₂ S₅, Li₂ S—P₂ S₅—GeS₂ (such as Li₁₃ GeP₃ S₁₆ and Li₁₀ GeP₂ S12), LiI—Li₂ S—P₂ O₅, LiI—Li₃ PO₄—P₂ S₅, and Li₇₋ₓ PS₆₋ₓ Clₓ; and combinations thereof.

The sulfide solid electrolyte may be a glass or a crystallized glass (glass ceramic).

When the negative electrode active material layer contains a solid electrolyte, the mass ratio (mass of silicon clathrate electrode active material:mass of solid electrolyte) of the silicon clathrate electrode active material to the solid electrolyte in the negative electrode active material layer is preferably 85:15 to 30:70, and more preferably 80:20 to 40:60.

The electrolytic solution preferably contains supporting salt of the electrolytic solution and a solvent.

Examples of the supporting salt (lithium salt) of the electrolytic solution having lithium-ion conducting properties include inorganic lithium salts such as LiPF₆, LiBF₄, LiClO₄, and LiAsF₆; and organic lithium salts such as LiCF₃ SO₃, LiN(CF₃ SO₂)₂, LiN(C₂ F₅ SO₂)₂, LiN(FSO₂)₂, and LiC(CF₃ SO₂)₃.

Examples of the solvent used in the electrolytic solution include cyclic esters (cyclic carbonates) such as ethylene carbonate (EC), propylene carbonate (PC), and butylene carbonate (BC); and chain esters (chain carbonates) such as dimethyl carbonate (DMC), diethyl carbonate (DEC), and ethyl methyl carbonate (EMC). The electrolytic solution preferably contains two or more solvents.

### (Conductive Aid)

The conductive aid is not particularly limited. For example, the conductive aid may be, but is not limited to, VGCF (vapor-grown carbon fiber), acetylene black (AB), ketjen black (KB), carbon nanotube (CNT), or carbon nanofiber (CNF).

### (Binder)

The binder is not particularly limited. For example, the binder may be of, but is not limited to, a material such as polyvinylidene fluoride (PVdF), butadiene rubber (BR), or styrene-butadiene rubber (SBR), or a combination thereof.

The thickness of the negative electrode active material layer may be, for example, 0.1 to 1000 μm.

### <Electrolyte Layer>

The electrolyte layer comprises at least an electrolyte. In addition, the electrolyte layer may comprise a binder in addition to the electrolyte, as needed. The above descriptions relating to the negative electrode active material layer of the present disclosure can be referenced regarding the electrolyte and the binder.

The thickness of the electrolyte layer, for example, is 0.1 to 300 μm, and preferably 0.1 to 100 μm.

### <Positive Electrode Active Material Layer>

The positive electrode active material layer is a layer containing a positive electrode active material and optionally a solid electrolyte, a conductive aid, and a binder.

T The material of the positive electrode active material is not particularly limited. For example, the positive electrode active material may be, but is not limited to, lithium cobaltate (LiCoO₂), lithium nickelate (LiNiO₂), lithium manganate (LiMn₂ O₄), LiCo_{1/3} Ni_{1/3} Mn_{1/3} O₂, a heteroelement-substituted Li—Mn spinel having a composition represented by Li₁₊ₓ Mn_{2-x-y} M_{y} O₄ (M is one or more metal elements selected from Al, Mg, Co, Fe, Ni, and Zn), lithium titanate (Liₓ TiO_{y}), or lithium metal phosphate (LiMPO₄, where M is one or more metals selected from Fe, Mn, Co, and Ni).

The positive electrode active material can comprise a covering layer. The covering layer is a layer containing a material that has lithium-ion conducting performance, has low reactivity with the positive electrode active material and the solid electrolyte, and can maintain the form of a covering layer that does not flow even when brought into contact with the active material or the solid electrolyte. Specific examples of the material constituting the covering layer can include, but are not limited to, Li₄ Ti₅ O₁₂ and Li₃ PO₄, in addition to LiNbO₃.

Examples of shapes of the positive electrode active material include particulate. The average particle size (D50) of the positive electrode active material is not particularly limited, and for example, is 10 nm or more, and may be 100 nm or more. The average particle size (D50) of the positive electrode active material is, for example, 50 μm or less, and may be 20 μm or less. The average particle size (D50) can be calculated from measurements with, for example, a laser diffraction particle size distribution analyzer or a scanning electron microscope (SEM).

The above descriptions relating to the negative electrode active material layer of the present disclosure can be referenced regarding the electrolyte, the conductive aid, and the binder.

When the positive electrode active material layer contains a solid electrolyte, the mass ratio (mass of positive electrode active material:mass of solid electrolyte) of the positive electrode active material to the solid electrolyte in the positive electrode active material layer is preferably 85:15 to 30:70, and more preferably 80:20 to 50:50.

The thickness of the positive electrode active material layer, for example, is 0.1 μm to 1000 μm, preferably 1 μm to 100 μm, and even more preferably 30 μm to 100 μm.

### <Positive Electrode Current Collector Layer>

The material used for the positive electrode current collector layer is not particularly limited. Any material that can be used as a positive electrode current collector of a battery can be appropriately adopted. For example, the material may be, but is not limited to, SUS, nickel, chromium, gold, platinum, aluminum, iron, titanium, zinc, or one of these metals plated or vapor-deposited with nickel, chromium, or carbon.

The shape of the positive electrode current collector layer is not particularly limited, and can include, for example, foil-like, plate-like, or mesh-like. Among these, a foil-like shape is preferable.

The lithium-ion battery manufactured by the method of the present disclosure may be a liquid-based battery containing an electrolytic solution as an electrolyte layer, and may be a solid-state battery having a solid electrolyte layer as an electrolyte layer. The “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte.

The lithium-ion battery manufactured by the method of the present disclosure may be a primary battery or a secondary battery.

The shape of the lithium-ion battery, for example, coin-type, laminate-type, cylindrical-type, square-type.

### EXAMPLES

### <<Synthesis of Silicone Clathrate Electrode Active Material>>

### <Alloying>

Si powder and sodium hydride (NaH) as a sodium (Na) source were used to manufacture a sodium-silicon (NaSi) alloy. It should be noted that the NaH used was preliminarily washed with hexane. The NaH and the Si powder having a porous structure were weighed at a molar ratio of 1.05:1, and the weighed NaH and Si powder having a porous structure were mixed with a cutter mill. The obtained mixture was heated under the conditions of 500° C. and 40 h in an argon atmosphere with a heating furnace to obtain a powdery NaSi alloy.

### <Clathration>

The obtained NaSi alloy and aluminum fluoride (AlF3) were weighed at a molar ratio of 1:0.35, and the weighed NaSi alloy and AlF3 were mixed with a cutter mill to obtain a reaction starting material. The obtained powdery reaction starting material was placed in a reaction vessel made of stainless steel and heated under the conditions of 310° C. and 60 h in an argon atmosphere with a heating furnace to allow a reaction to obtain a sodium-containing silicone clathrate (Na₂₀Si₁₃₆).

### <Sodium Removal>

### Example 1

The obtained Na₂₀Si₁₃₆ was added 100 ml of ethanol and 3.71 ml of a 46% by mass hydrogen fluoride (HF) aqueous. The solution was filtered and the filtered solids were washed eight 8 times with 25 ml of ethanol and dried at 60° C. in vacuo overnight. As a result, a silicone clathrate electrode active material of Example 1 was obtained, in which at least a portion of sodium was removed from Na₂₀Si₁₃₆.

### Comparative Example 1

Na₂₀Si₁₃₆ and zinc chloride (ZnCl₂) were weighed at a molar ratio of 1:0.75, and weighed Na₂₀Si₁₃₆ and ZnCl₂ were mixed to obtain a powdery reaction raw material. The powdery reaction raw material was placed in a stainless steel reaction vessel, and the reaction was made by firing at 430° C. in an Ar atmosphere in a heating furnace. The reaction products were washed using a mixed solvent in which HNO₃ and H₂O were mixed at a volume ratio of 10:90. Thus, by-products in the reaction product were removed. After washing, the filtered and filtered solids were dried at 120° C. for 3 h or more to obtain a silicon clathrate electrode active material of Comparative Example 1.

### Comparative Example 2

A silicon clathrate electrode active material of Comparative Example 2 was obtained in the same manner as in Comparative Example 1 except that the firing temperature was 450° C.

### <<Evaluation>>

<Treatment Capacity of Na₂₀Si₁₃₆>

The treatment capacity per day of Na₂₀Si₁₃₆ in the sodium removal step was calculated and taken as a relative value when the value of Comparative Example 1 was set to 1.

<Amount of Sodium after Sodium Removal Step>

The amount of sodium remaining in the silicon clathrate electrode active material after the sodium removal step was measured by inductively coupled plasma (ICP) analysis.

### <<Results>>

Evaluation results are shown in Table 1.

TABLE 1

| | | Treatment | Amount of Na in |
|---|---|---|---|
| | | capacity (relative | electrode active |
| | Na removal method | value) | material [%] |
| Example 1 | Treated with HF | 20 | 4.55 |
| Comparative | Mixed with ZnCl₂ | 1 | 14.9 |
| Example 1 | →fired (430° C.) | | |
| Comparative | Mixed with ZnCl₂ | 0.0375 | 6.7 |
| Example 2 | →fired (450° C.) | | |

As shown in Table 1. In the method of Example 1, in which sodium removal from Na₂₀Si₁₃₆ was performed by treatment with HF. Treatment capacity of Na₂₀Si₁₃₆ was large and the amount of sodium remaining in the silicon clathrate electrode active material was small.

1. A method for manufacturing a silicon clathrate electrode active material, comprising the following steps:
(a) providing a sodium-containing silicon clathrate; and
(b) contacting the sodium-containing silicon clathrate with a hydrogen fluoride solution to remove at least a portion of sodium from the sodium-containing silicon clathrate.

2. The method according to claim 1, wherein the solvent of the hydrogen fluoride solution is a mixed solvent of water and an organic solvent.

3. The method according to claim 1, wherein the sodium-containing silicon clathrate has a porous structure.

4. The method according to claim 1, wherein the silicon clathrate electrode active material is for a negative electrode active material of lithium-ion batteries.

5. A method for manufacturing a lithium-ion battery, comprising the following steps
manufacturing a silicone clathrate electrode active material by the method according to claim 1, and
forming an electrode active material layer containing the silicon clathrate electrode active material.
